(19) United States
(12) Patent Application Publication
(10) Pub. No.: US 2006/0184893 A1
(43) Pub. Date: Aug. 17, 2006

(54) Graphics controller providing for enhanced control of window animation

(76) Inventors: Raymond Chow, Richmond (CA); Victor Ga-Kui Chan, Richmond (CA)

Correspondence Address: EPSON RESEARCH AND DEVELOPMENT INC;INTELLECTUAL PROPERTY DEPT, 150 RIVER OAKS PARKWAY, SUITE 225, SAN JOSE, CA, 95134, US

(21) Appl. No.: 11/060,265

(22) Filed: Feb. 17, 2005

(51) Int. Cl. G06F 3/00

(52) U.S. Cl. 715/781

(57) ABSTRACT

A graphics controller providing for enhanced window control interfaces between a host and a graphics display device. The graphics controller includes a memory, a fetching module and a window translating module. The memory stores at least a portion of the image data corresponding to a first window of image data received by the graphics controller from the host. The fetching module first fetches the first portion of the image data to produce at least part of a first data stream. The first data stream is in a parallel, clocked relation to a second data stream of the image data corresponding to a second window of image data received by the graphics controller from the host. The first and second data streams are provided to the graphics display device for display as multiple windows thereon. The window translating module is coupled to the fetching module and temporally shifts the first fetching to provide a corresponding spatial translation of the first window with respect to the second window as displayed on the graphics display device.

### FIELD OF THE INVENTION

The present invention relates to a graphics controller providing for enhanced control of window animation.

### BACKGROUND

In a graphics display system, such as a cellular telephone, a graphics controller is often provided for interfacing between one or more hosts, such as a central processing unit (“CPU”), digital signal processor (“DSP”), or camera, and a graphics display device, such as a liquid crystal display (“LCD”). While in principle the host may interface directly with the display device, provided that the host's read/write operations conform to the protocol specified for the display device, use of the graphics controller reduces the requirements on the host and increases system efficiency. The graphics controller is typically a separate, dedicated integrated circuit (“IC”), which provides specialized functions related to driving the graphics display device.

The functions of the graphics controller typically include JPEG encoding of outgoing image data for transmission and decoding of incoming image data for display, cropping or otherwise resizing images, and translating image data from one color space to another. In telephone and other systems used for data communications, graphics controllers are used for both wireless and wired communications.

The graphics controller also receives commands from the host and controls the graphics display device according to the commands, such as by enabling or disabling a particular display panel of a device and by specifying display parameters such as image size and color resolution.

Typically, the graphics controller includes an internal memory for storing image data received from a host. The internal memory has been used differently in different graphics controllers. In a first exemplary prior art graphics controller, the internal memory includes a portion known as a “frame buffer” that is used for storing a “frame” of image data, i.e., all of the image data that is to be displayed as pixels by the graphics display device. Typically, the data are moved from the frame buffer to the display in a raster-scan order, the frame defining the image seen on the display. Additionally, the internal memory of the first exemplary graphics controller often includes a “non-display” portion (“non-display memory”).

It is known to display a plurality of “windows” of image data, where all or a portion of one window may overlay, and thereby mask all or a portion of another window. Image data for the windows are stored in the non-display memory. Particularly, the image data corresponding to one of the windows is stored in one portion of the non-display memory, and the image data corresponding to another of the windows is stored in another portion of the non-display memory. Since the windows may overlap, it is not necessary to display all of the image data corresponding to both windows. Accordingly, the first exemplary graphics controller therefore fetches from the non-display area only the image data that will be displayed. The fetched data is re-stored in the frame buffer portion of the internal memory for subsequent fetching and writing to the display panel. In the first exemplary graphics controller, this moving of image data from non-display memory to the frame buffer is typically facilitated by a BitBLT engine.

It was recognized in the prior art that it would be desirable to reduce or eliminate the time and power consumed in shuffling image data from the non-display memory to the frame buffer. According to this recognition, a second exemplary graphics controller has been provided that stores the image data only once. In the second exemplary graphics controller, a separate frame buffer portion is not provided. Particularly, image data associated with one window are stored in one portion of the internal memory and image data associated with another window are stored in another portion of the internal memory. Typically, there are only two windows; one of the windows is referred to as a “main window” and the other window is referred to as a “sub-window,” where the sub-window overlays the main window and therefore has priority over the main window. In this specification, the portion of the internal memory used for storing image data associated with the main window is referred to as a main window memory, and the portion of the internal memory used for storing image data associated with the sub-window is referred to as a sub-window memory.

In the second exemplary graphics controller, image data of the main window and sub-window memories are clocked out in parallel data streams. For data corresponding to each pixel, a selecting circuit dynamically selects one of the data streams or the other for input to the graphics display device. For example, to display pixels of the main window that are not overlaid by corresponding sub-window pixels, the selecting circuit selects the main window data stream. However, to display pixels for which there are both main window data and sub-window data, the selecting circuit selects the sub-window data stream.

It is particularly important in inexpensive, battery powered, portable systems such as cellular telephones to minimize the processing overhead imposed on the host and to minimize overall system power consumption.

Further, to an ever-increasing extent, additional display features are desired by consumers, particularly animation in such systems. For example, in a mobile telephone, typically, the sub-window is a camera image, and the main window is a background that includes icons used for selecting features. It is sometimes desirable to change the background (main window) underneath the camera image without disturbing the camera image (sub-window). More particularly, it may be desirable to move the background from side to side, or up and down, underneath the camera image to draw attention to the occurrence of an event, such as the receipt of an email, without using a ring tone and without detracting too much from viewing of the camera image.

Changing the main window displayed underneath sub-window without disturbing the sub-window, and other similar features, are expensive in terms of host overhead and power consumption. Therefore, there is a strong motivation to use the second exemplary graphics controller instead of the first exemplary graphics controller.

Changing the main window without disturbing the sub-window can be implemented in the first exemplary graphics controller by having the host specify, at all necessary times, the location of each window on the display. However, this imposes an undesirable burden on the host.

In the second exemplary graphics controller, the data transfer from the non-display memory to the frame buffer is eliminated. The host may control window positioning by writing data to the frame buffer, but once the data are written to the frame buffer, the second exemplary graphics controller does not permit changes to the relative positioning of the windows.

Accordingly, there is a need for a graphics controller providing for enhanced control of window animation that provides the desired control with a minimum consumption of system resources and power.

### SUMMARY

A graphics controller providing for enhanced control of window animation is disclosed for interfacing between a host and a graphics display device. A preferred such graphics controller includes a memory, a fetching module and a window translating module. The memory stores at least a portion of the image data corresponding to a first window of image data received by the graphics controller from the host. The fetching module first fetches the first portion of the image data to produce at least part of a first data stream. The first data stream is in a parallel, clocked relation to a second data stream of the image data corresponding to a second window of image data received by the graphics controller from the host. The first and second data streams are provided to the graphics display device for display as multiple windows thereon. The window translating module is coupled to the fetching module and temporally shifts the first fetching to provide a corresponding spatial translation of the first window with respect to the second window as displayed on the graphics display device.

Preferably, the shift or, equivalently, the spatial translation is defined by the host writing control data to one or more registers in the graphics controller.

Preferably, one or more additional modules are also provided: A visual effects module produces a selectably defined visual effect according to a determination whether there are no image data corresponding to either the first or second windows; a selecting module selects image data according to a selectably defined priority from one of the first and second data streams according to a determination whether the first and second windows overlap; a combining module forms a selectably defined combination of the image data of the first and second data streams according to a determination whether the first and second windows overlap. Preferably, the visual effect, the priority and the combination are all selectably defined by the host writing control data to the one or more registers.

It is to be understood that this summary is provided as a means of generally determining what follows in the drawings and detailed description and is not intended to limit the scope of the invention. Objects, features and advantages of the invention will be readily understood upon consideration of the following detailed description taken in conjunction with the accompanying drawings.

### BRIEF DESCRIPTION OF THE DRAWINGS

FIG. 1 is a block diagram of a graphics display system incorporating a first graphics controller according to the prior art.

FIG. 2 is a pictorial illustration of the display area of a graphics display device showing a main window and a sub-window.

FIG. 3 is a block diagram of a graphics display system incorporating an improved graphics controller according to the prior art.

FIG. 4A is a pictorial illustration of the display area of a graphics device showing a main window and a sub-window in first positions.

FIG. 4B is a pictorial illustration of the main and sub-window of FIG. 4A, where the main window has been intentionally translated to the left.

FIG. 5 is a block diagram of a graphics display system having a graphics controller comprising a window management module according to the present invention.

FIG. 6A is a schematic illustration of fetching, in parallel, from main and sub-window memories in the graphics controller of FIG. 4, to provide corresponding data streams of image data.

FIG. 6B is a pictorial illustration of the display area of a graphics display device showing the locations of main and sub-window pixels obtained from the data streams of FIG. 6A.

FIG. 6C is a pictorial illustration of the display area of FIG. 6B with the sub- window translated two pixels to the right.

FIG. 6D is a schematic illustration showing the data streams of FIG. 6A in a time-shifted relationship to provide the translation of FIG. 6C.

FIG. 7 is a schematic illustration of a portion of the display area of a display device showing a range of pixels populated by a combining module according to the present invention providing a first tier of functionality according to the invention.

FIG. 8 is a schematic illustration of the display area and pixels of FIG. 7 showing the pixels populated by the combining module according to a second tier of functionality according to the invention.

FIG. 9 is a block diagram of the graphics display system of FIG. 5 where the window management module includes an alternative partial panel update module according to the present invention

### DETAILED DESCRIPTION OF PREFERRED EMBODIMENTS

The invention is directed to a graphics controller providing for enhanced control of window animation. Reference will be made in detail below to preferred embodiments of the invention, examples of which are illustrated in accompanying drawings. Wherever possible, the same reference numbers are used in the drawings and the description to refer to the same or like parts.

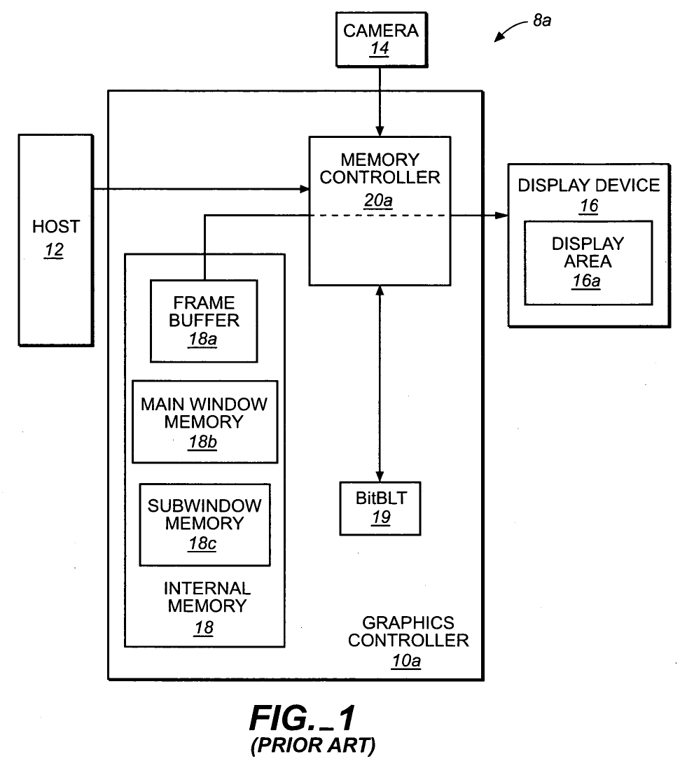

To provide context for the invention, FIG. 1 shows a graphics display system 8a employing an example of the first prior art graphics controller described above, referenced as 10a. As is typical in mobile telephones, the system 8a also includes a host 12, a camera 14, and a graphics display device 16, the graphics controller interfacing between the host and camera, on the one hand, and the graphics display device, on the other. Only pertinent details of the graphics controller 10a are shown.

The graphics controller 10a includes an internal memory 18 for receiving image data from the host 12 and from the camera 14. More particularly, the internal memory 18 is partitioned into three parts, a frame buffer 18a, a main window memory 18b, and a sub-window memory 18c. In this specification, the frame buffer is referred to as a display area of the memory 18 and the main and sub-window memories are referred to as non-display areas of the memory 18. The main window memory 18b is used for storing image data corresponding to a main window, which are typically received from the host 12. The sub-window memory 18c is used for storing image data corresponding to a sub-window, which are typically received from the camera 14. Other windows could be provided, where the memory 18 would be partitioned further as appropriate.

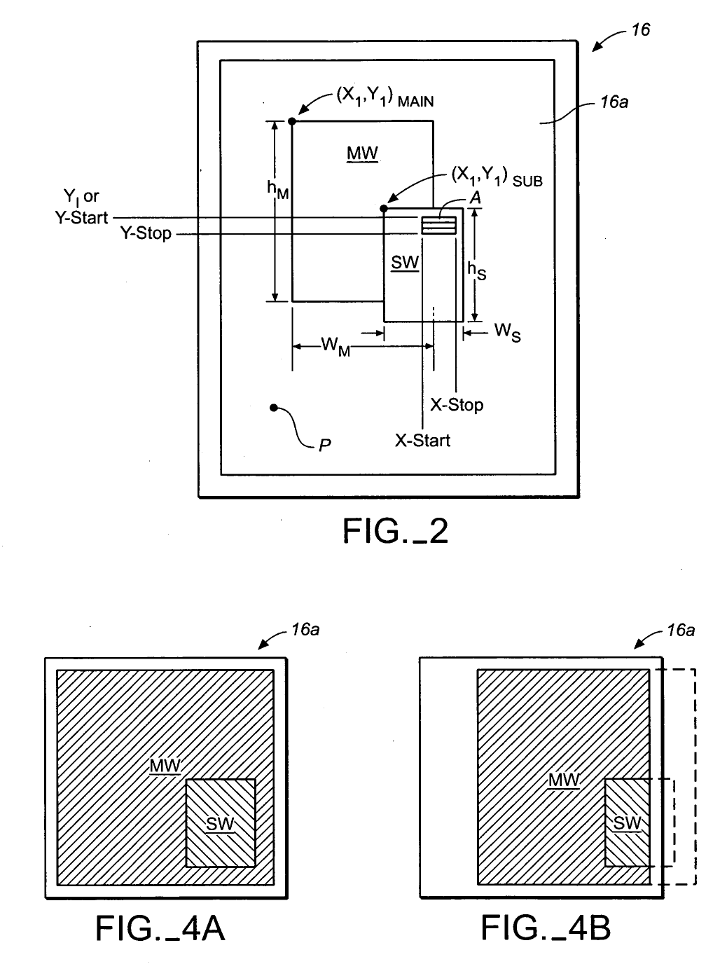

Referring to FIG. 2, the graphics display device 16 has a graphics display area 16a for displaying pixels of image data. Typically, a main window “MW” and a sub-window “SW” are displayed within the display area 16a. Windows define corresponding sets of pixels for display on the display device 16, where each pixel in a set of pixels is positionally related on the display area 16a of the display device to other pixels within the set.

The sub-window has priority over the main window, meaning that the sub-window overlays the main window. According to this priority, for any particular pixel of the display area 16a at which there is valid main window image data and valid sub-window image data, the sub-window image data for the pixel are displayed while the main window image data for the pixel are suppressed.

A memory controller 20a stores incoming image data from the host 12 and camera 14 in the appropriate non-display memories, e.g., the image data from the host are stored in the main window memory 18b and the image data from the camera are stored in the sub-window memory 18c. Further, the memory controller 20a fetches image data from both the non-display memories 18b and 18c to populate the frame buffer 18a. For each pixel of the display area 16a, there is a corresponding memory location(s) for storing image data corresponding to the pixel in the frame buffer 18a. The image data are selectively fetched from the non-display areas of the memory 18 for storage in the frame buffer according to the priority of the image data, i.e., the priority of the window to which the image data correspond.

Under this prior art methodology, all of the image data that are ultimately displayed are stored and fetched twice; first the image data are stored in the non-display area of the memory 18 and subsequently fetched for storage in the display area of the memory, then the image data are stored in the display area of the memory 18 and subsequently fetched from the display area for transmission to the display device. While use of a BitBLT engine (19) to facilitate the data transfers relieves the host of some processing overhead, the transfers impose costs in power consumption and system speed.

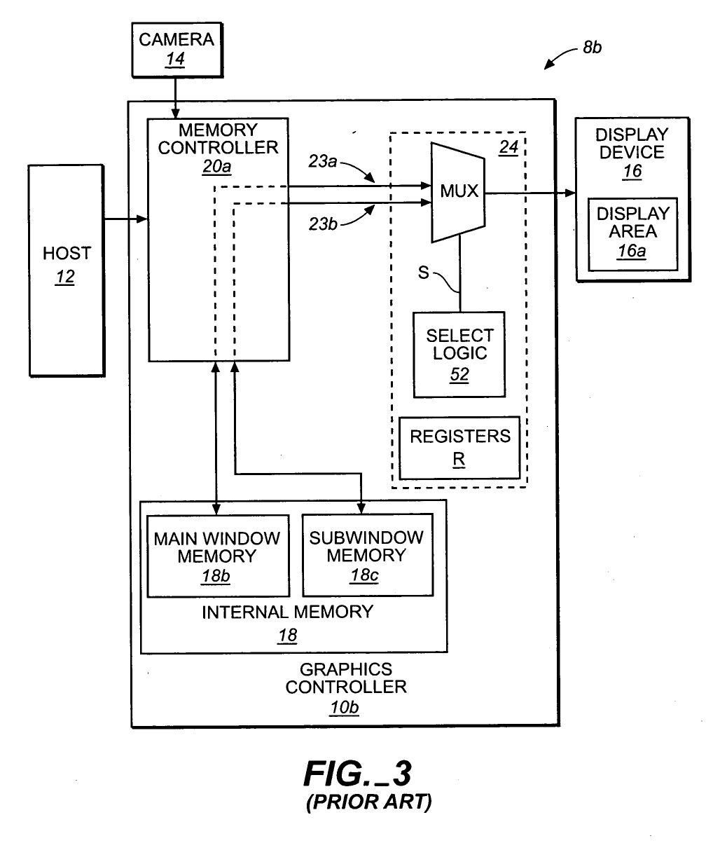

Turning to FIG. 3, a graphics display system 8b is shown that is similar to the system 8a except that it employs, in place of the first exemplary prior art graphics controller 10a, a second exemplary prior art graphics controller 10b. The graphics controller 10b includes an internal memory 18 partitioned into two portions: a main window memory 18b, and a sub-window memory 18c. As in the graphics controller 10a, the main window memory 18b is used for storing image data corresponding to a main window, and the sub-window memory 18c is used for storing image data corresponding to a sub-window. Moreover, other windows and associated storage areas in the memory 18 could be provided.

A memory controller 20b stores incoming image data from the host 12 and camera 14 in the appropriate memories, e.g., the image data from the host are stored in the main window memory 18b and the image data from the camera are stored in the sub-window memory 18c. The memory controller 20b further fetches image data from both the memories 18b and 18c for direct transmission to the display device 16. The data are fetched from the memory 18 for transmission to the display device in a predetermined, sequential order, typically a raster-scan order. More particularly, the data are fetched in parallel from the two memories to produce two parallel data streams 23a, 23b that are in a fixed clocked relation to one another.

The data in the data streams are associated with particular pixels for display. The data streams are received by a selecting circuit 24. For each pixel, selecting circuit 24 selects the data stream corresponding to the window that has priority. This can be implemented in hardware with a multiplexer (“MUX”) controlled by a select signal “S” issuing from select logic “SL.” The host may control the select logic by writing to one or more registers “R.” As a result, for any particular pixel of the display area 16a, the sub-window image data for the pixel are displayed while the main window image data for the pixel are suppressed.

Under this second prior art methodology employing the graphics controller 10b, the image data that are ultimately displayed are stored and fetched only once, providing a significant improvement in system efficiency as compared to using the graphics controller 10a.

According to the invention, a graphics display controller capable of providing additional display features, such as animation of the windows, is desired. A particular example of such an additional display feature, which is not intended to be limiting, is to animate the main window while leaving the sub-window positionally fixed on the display device.

The graphics controller 10a may be used to provide such a feature with the drawbacks described above. On the other hand, while providing the above indicated advantages over the graphics controller 10a, the graphics controller 10b may not be used to provide such a feature and an improved graphics display system is needed. FIGS. 4A and 4B illustrate the problem encountered when using the system 8b.

FIG. 4A shows first positions of a main window MW and a sub-window SW on the display area 16a of the graphics display device 16 employed in the system 8b. FIG. 4B shows the result of translating the main window MW to the right, which may occur, for example, if the main window image is being “panned.” As illustrated, the sub-window SW moves along with the main window, an undesirable result.

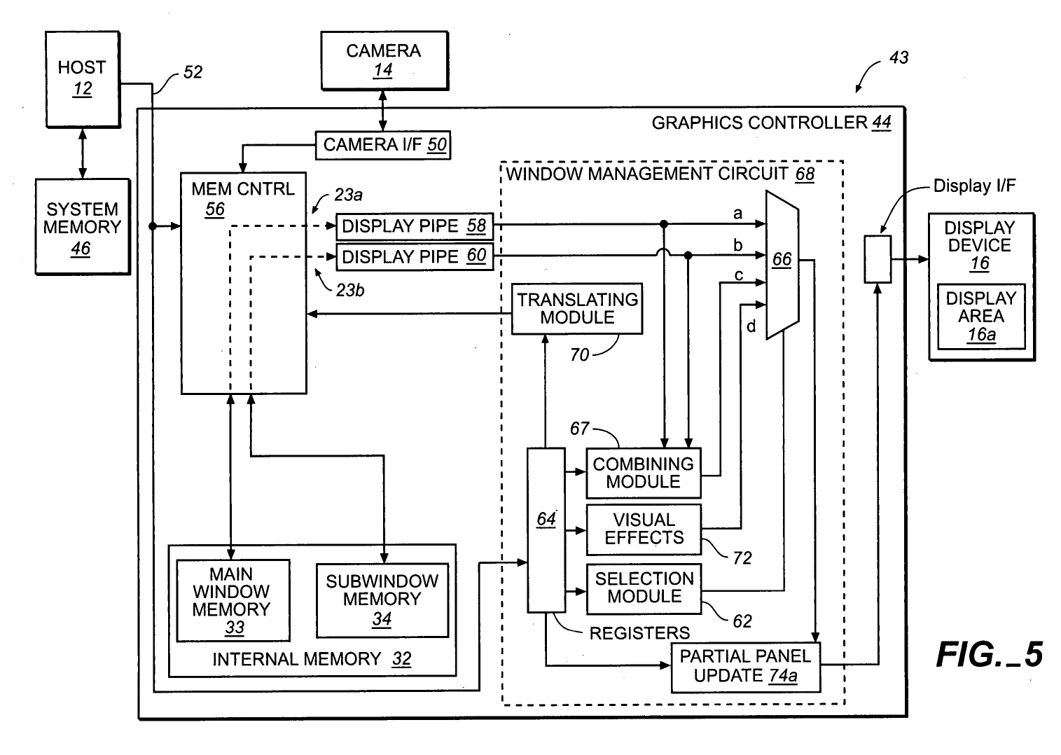

Turning now to FIG. 5, a preferred graphics display system 43 solving the aforementioned problem according to the invention is shown. The graphics display system 43 may be any digital system or appliance providing graphics output, but the graphics controller 44 is particularly advantageous for use in a portable system that is powered by a battery (not shown), where reduced power consumption is particularly important. Such a preferred system 43 is a mobile (or cellular) telephone. An alternative preferred graphics display system is a personal digital assistant (“PDA”). However, the term “graphics display system” is used in this specification to broadly refer to any of a wide variety of devices, including but not limited to mainframe, personal, server, and embedded computers.

The system 43 includes a standard host 12 and graphics display device 16, and the graphics controller 44 interfaces between the host and the display device. The graphics controller is typically and preferably a single IC, separate from the host and display device.

The host 12 is preferably a microprocessor, but may be a computer, a CPU, an MPU, a DSP, or any other provider of image data. The system 43 preferably includes a system memory 46 accessible by the host 12 and external to the graphics controller 44.

The system 43 also preferably, though not necessarily, includes a camera 14 that also provides image data to the graphics controller 44 via a camera interface 50. The camera 14 typically outputs the image data as an asynchronous stream to the graphics controller 44.

A camera may be any image capture device, including but not limited to still and video cameras, image scanners, and similar devices. More broadly, a camera may be any provider or source of digital image data, such as a network interface or a JPEG decoder. As a source or provider of image data, a camera is also a host.

The display device 16 is preferably an LCD panel, but any device(s) capable of rendering pixel data in visually perceivable form may be employed, such as CRT, LED, OLED, and plasma, without regard to the particular display technology employed. The display device may also be a hardcopy device, such as a printer or plotter.

The graphics controller 44 receives data and instructions from the host 12 over a bus 52, and receives data from the camera over the camera interface 50. The bus 52 may be serial or parallel, and may be organized to transmit the data and instructions over the same line(s) or over separate line(s) of the bus.

Where the camera 14 is provided, as in the prior art graphics display systems discussed above, image data from the camera are typically associated with a sub-window (“SW,” FIGS. 2, 4A, 4B) in the graphics controller 44 and on the display device 16, while image data from the host 12 are typically associated with a main window (“MW,” FIGS. 2, 4A, 4B), but this is not essential. Usually, the main window MW is fixed and the graphics controller 44 provides the capability to move (or translate) the sub-window SW. However, according to the invention, the graphics controller 44 provides enhanced window control for moving, or animating, the main window in addition to or in alternative to moving the sub-window.

The graphics controller 44 includes an internal memory 32 for storing image data received from the host 12 and the camera 14. The memory 32 is partitioned into two non-display memories; a main window memory 33 and a sub-window memory 34 for storing main window and a sub-window image data, respectively.

A memory controller 56 stores incoming image data from the host 12 and camera 14 in the appropriate non-display memories, e.g., the image data from the host are stored in the main window memory 33 and the image data from the camera are stored in the sub-window memory 34. Further, the memory controller 56 fetches image data from both the non-display memories 33, 34 for direct transmission to the display device 16. The data are fetched from the memory 32 to produce data streams 23a, 23b output from the main and sub-window memories 33 and 34, respectively, for transmission to the display device in a predetermined, sequential order, typically a raster-scan order.

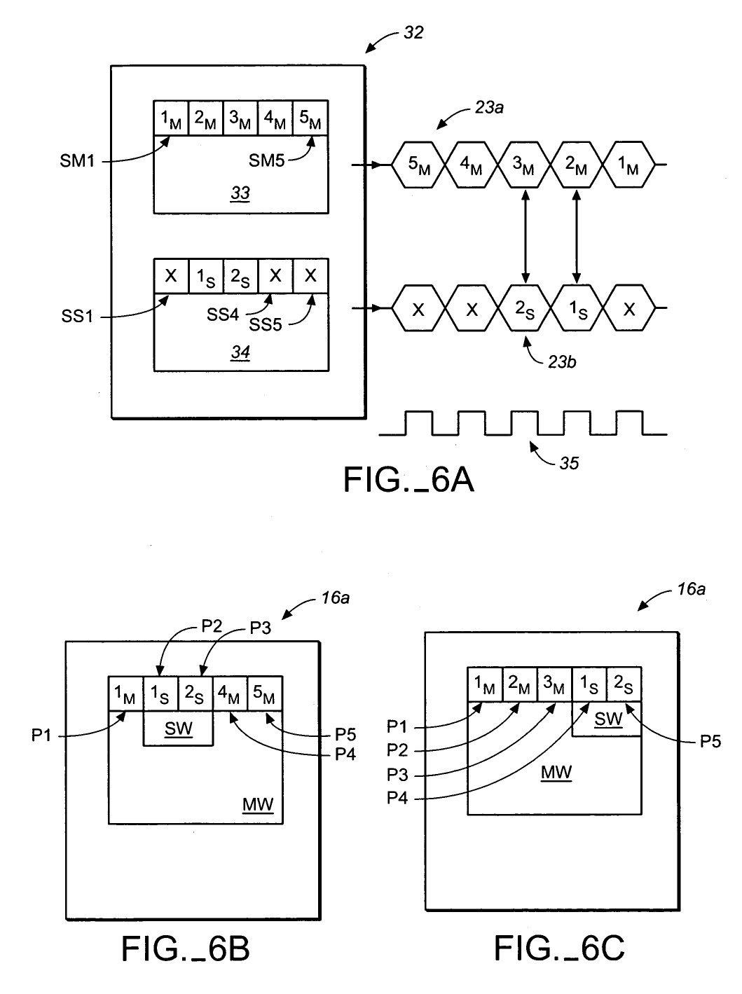

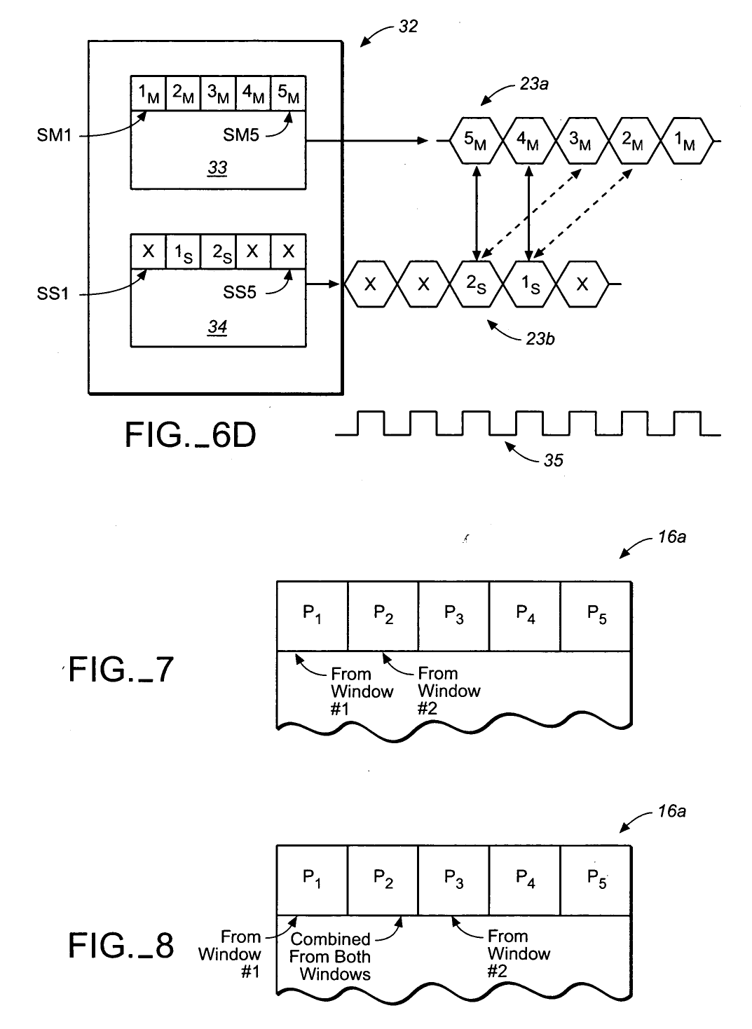

For example, FIG. 6A shows a main window memory 33 in the memory 32 having five memory storage locations SM1-SM5 for storing image data 1_{M}-5_{M}. Referring to FIG. 6B, the image data 1_{M}-5_{M} is for display at a respective five pixel locations P1-P5 on the display area 16a of the display device 16. FIG. 6A also shows a sub-window memory 34 in the memory 32 having two storage locations SS1 and SS2 for storing image data 1_{S}-2_{S.} Referring again to FIG. 6B, the image data 1_{S}-2_{S} is for display at a respective two of the pixel locations P1-P5 of FIG. 2, particularly the pixel locations P2 and P3, respectively.

For an exemplary raster scan order of fetching, data in the main window memory 33 are fetched in the order 1_{M}, 2_{M}, 3_{M}, 4_{M}, 5_{M}, and data in the sub-window memory 34 are fetched in the order 1_{S}, 2_{S}.

Preferably according to the invention and as shown in FIG. 6A, the sub-window memory is as large as the main window memory so that either window may fill the display area 16a of the display device. However, if, as is typical, the sub-window as displayed is smaller than the main window, some of the data in the sub-window memory will be irrelevant as indicated by an “X” (i.e., “don't care”) as shown in locations SS1, SS4, and SS5.

The locations of a main window “MW” and a sub-window “SW” displayed on the display area 16a are shown in FIG. 6B. The locations of “MW” and “SW” are according to the data positioned as shown in FIG. 6A.

The data are fetched from the memories 33 and 34 in time with a synchronizing, periodic clock signal 35. More particularly, the data are fetched from the memories in parallel in time with the clock signal. For example, referring to FIG. 6A, on a first clock pulse, data of the data stream 23a from main window memory storage location SM1 are output, i.e., datum 1_{M}. On this first clock pulse, either no data of the data stream 23b are output from the sub-window memory or data having a “don't care” value are output in parallel. On a second clock pulse, data at main window memory storage location SM2 are output in parallel with data at sub-window memory storage location SS1, i.e., data 2M and 1S, respectively. On a third clock pulse data at main window memory storage location SM3 are output in parallel with data at sub-window memory storage location SS2. On a fourth clock pulse data at main window memory storage location SM4 are output, and so on. The data are therefore output from the main window memory 33 and the sub-window memory 34 in parallel data streams 23a and 23b as shown. This clocking relation between the two data streams 23 is indicated graphically by the arrows.

Preferably, referring again to FIG. 5, two FIFO “display pipes” 58, 60 are provided for receiving the data streams 23a and 23b, respectively, and transmitting or propagating the data therein to a window management circuit 68. The pipes provide an important, though not necessarily essential, buffering function where the system 43 employs a graphics display device that does not have its own internal memory; however, this buffering function may be unnecessary where the graphics display device includes an internal memory.

According to the invention, the window management circuit 68 provides a number of features, one of which is to provide for animating the windows independently of one another at minimum system cost in terms of host overhead, power consumption, and speed. To provide this function, the window management circuit 68 includes a translation module 70 adapted to spatially translate one of the windows with respect to another of the windows. For example, the translation module may provide for translating the sub-window SW with respect to the main window MW as these windows are shown in FIG. 6B, to achieve the result shown in FIG. 6C, i.e., that the sub-window is translated two pixels to the right while the location of the main window remains the same. This function may be provided by instructing the memory controller 56, or it may be provided in conjunction with delay circuits interposed between the memory 32 and the pipes 58, 60, or disposed downstream of the pipes.

Turning to FIG. 6D, to achieve the desired spatial translation, the translation module 70 temporally shifts the clocking relation between the two data streams 23. Particularly in this example, the timing for clocking image data out of the sub-window memory 34 (data stream 23b) is delayed by two cycles with respect to the timing for clocking image data out of the main window memory 33. Accordingly, where image data 2_{M}, 3_{M} issuing from the main window memory were clocked so as to temporally correspond to image data 1_{S}, 2_{S}, respectively, issuing from the sub-window memory as shown by the dashed arrows in FIG. 6D, it is now the case that image data 4_{M}, 5_{M} temporally correspond to image data 1_{S}, 2_{S} as indicated by the solid arrows. As a result, the sub-window is spatially translated independent of the main window.

While described in connection with translating the sub-window relative to the main window, the same methodology is used to spatially translate the main window independently of the sub-window. Further, according to the invention, either (or any) window may be designated to have priority, as discussed below. Accordingly, the labels “main window” and “sub-window” are used for illustrative purposes only. It can also be readily appreciated that the translation module 70 may employ the same processing strategy for translating a window vertically as well as horizontally, and in either direction.

While described in the context of storing entire windows of image data in the memory 32, it will be appreciated that the translation module may operate on data received by the graphics controller that are not stored in the memory, so long as at least enough data are stored to permit the required time-shifting. It will also be appreciated that it is not necessary to store image data from both of two windows that are translated relative to one another, it being necessary only to store those data corresponding to the window that is being delayed in time. The memory 32 may be downsized accordingly.

The translation module 70 is responsive to control data received from the host for defining the amount of translation desired. The control data are preferably parameters which are preferably stored in one or more registers 64 in the window management module 68, from which an amount and direction of temporal shift can be directly determined, or the control data may be used to specify one or more predetermined translation programs of any desired complexity provided by the window management module 68.

The data streams, temporally aligned as desired as explained above, are transmitted by the display pipes 58, 60 to a selection module 62, which may include a multiplexer 66 as shown, for selecting one or the other pipes as in the prior art. However, the window management module 68 includes in addition a combining module 67 and a visual effects module 72 producing outputs that are also multiplexed with the raw data obtained directly from the display pipes. Further, the selection module 62 also provides for permitting specification, by the host, of the priority of the two data streams 23, for specifying the priority of multiple windows.

The outputs of the display pipes 58 and 60 are provided to the multiplexer 66 at inputs “a” and “b” thereof, respectively. The outputs of the combining module 68 and the visual effects module 72 are provided to the multiplexer at inputs “c” and “d” thereof, respectively. A selecting signal “SEL” selects one of the inputs a, b, c, and d, to provide for displaying a selected one of the following:
(1) image data corresponding to a first window;
(2) image data corresponding to a second window;
(3) a selected combination of first and second window image data; and
(4) a selected visual effect for pixel locations falling outside of both windows.

The host 12 writes control data to the registers 64 that are used by the window management module 68 to determine the selecting signal SEL, which may have in the preferred embodiment four different values (for managing two windows) as indicated above. The signal SEL is determined for each pixel on the display device. To determine the selecting signal SEL for any given pixel on the display device, the selection module 62 determines whether:
(5) there are only first window image data corresponding to the pixel;
(6) there are only second window image data corresponding to the pixel;
(7) there are both first and second window image data corresponding to the pixel (i.e., the windows overlap); and
(8) there are no image data corresponding to the pixel for either window.

If (5) there are only first window image data corresponding to a given pixel, then the selection module 62 selects the first window image data input “a” of the multiplexer 66. Similarly, if (6) there are only second window image data corresponding to the given pixel, then the selection module selects the second window image data input “b” of the multiplexer 66.

However, if (7) there are both main and sub-window image data for a given pixel, the window management module further determines according to the invention whether and how to combine image data from multiple windows.

It is an outstanding feature of the invention that the control data may specify the priority of multiple windows so that the selection module 62 selects the data input corresponding to the window having the highest priority, thus ensuring that windows with lower priority will be overlaid by windows having higher priority. The invention may also provide for combining the image data for multiple windows, either without regard to priority or in consideration thereof, by the combining module 67 as discussed further below.

If (8) there are no image data corresponding to either window, the window management module further determines according to the invention whether to apply a special visual effect and, if a visual effect is desired, to select the visual effect.

The window management module 68 preferably minimizes host processing requirements and the control data are therefore preferably provided at a relatively high level of abstraction. For example, to determine all the pixels for which there are (1) main window image data, (2) sub-window image data, or (3) both, the host may minimally specify, through the control data, the size of each window (e.g., heights “h_{M},” “h_{S},” and widths “w_{M},” “w_{S},” for the main and sub-windows MW and SW, respectively, in FIG. 2), and the location, on the display area 16a of a point on each window (e.g., locations (x₁, y₁)_{MAIN} and (x₁, y₁)_{SUB} for the main and sub-windows in FIG. 2). The preferred window management module 68 is adapted to make the determinations (5)-(8) for any pixel based on these or equivalent specifications, this adaptation being capable of implementation in numerous ways as will be readily appreciated by persons of ordinary skill.

As mentioned, the control data are preferably stored in one or more registers 64 of the window management module 68. However, the control data may be stored in the memory 32 or in any other suitable storage device. Also as will be readily appreciated, the registers 64 may be combined or separated as desired, and as many or as few registers may be provided as is needed to define to the graphics controller 44 the desired specifications.

The control data may specify a visual effect by use of a predetermined code recognized by the visual effects module 72. The visual effects module 72 provides predetermined image data that are not necessarily derived from image data provided from an external source, such as the host 12 or the camera 16. Preferably, the output from the visual effects module 72 is selected for specifying background image data for display at pixel locations falling outside the windows being displayed. Thence, the visual effects module 72 supports the translation module 70 in that the translation module permits translating the main window so as to leave pixels of the display area 16a of the display device 16 undefined by image data corresponding to any window. Such a condition does not arise in the prior art where, when more than one window is provided, the “main” window fills the display, and no provision is made to move the main window so that it does not fill the display.

Referring back to FIG. 2, wherein the main window MW is shown overlaid by the sub-window SW, a visual effect may be applied to a pixel falling outside both of the windows such as the location indicated as “P.” As an example, the visual effects module 72 is preferably adapted to specify, for each such pixel location P, one of a number of alternative choices of color, so that a background color of choice may be specified by a designer or user of the system 43. The visual effect may be static or dynamic, for example, the color may be unchanging or flashing.

Pixel locations P may be grouped in a predetermined manner to display different colors or the visual effects module 72 may provide for specifying only one color, i.e., providing no options. Moreover, visual effects other than color may be provided by the visual effects module 72 as desired. Further, the visual effects module 72 may provide no visual effect in selected pixel locations P, effectively turning off or only minimally driving portions of the display screen in order to conserve power.

Any number of predetermined image data may be coded, and codes may specify, in addition to the image data, a pattern for repeating the image data Coding the background provides the outstanding advantage of conserving memory which would otherwise be devoted to storing background image data. The visual effects module applies the coded color choice “on the fly” so that corresponding color data need not be stored in the internal memory as a bit-map, providing an outstanding memory savings. -Where a pattern of image data are repeated, memory requirements may be limited to storing one instance of the pattern and data defining the rate or manner of repetition of the pattern. For example, to code a repetitive rectangular pattern, the control data may include image data defining the rectangular pattern along with parameters specifying the spacing or relative positioning of an adjacent rectangle.

The control data may specify a program of combining image data corresponding to multiple windows by use of a predetermined code recognized by the combining module 67. The combining module 68 may combine image data in any desired manner and preferably provides two tiers of functionality. In a first tier, the combining module specifies how image data for multiple, overlapping windows are combined to produce a composite datum for display at a particular pixel location in the display area 16. An example of first tier functionality is averaging the image data corresponding to one of the windows with the image data corresponding to another of the windows to produce composite image data for display at a given pixel location. In addition or as an alternative to arithmetic functions such as averaging, predetermined methodologies for combining image data according to the invention may provide logical functions, such as AND, OR, and NOT. Priority may be taken into account, e.g., by weighting more heavily the image data corresponding to a higher priority window.

In a second tier of functionality that may also be provided by the combining module 68, the combining module 68 specifies how image data for multiple, overlapping windows are to be distributed over a range of pixel locations. Referring to FIG. 7, an example of second tier functionality is shown. FIG. 7 shows a range of pixels “P1-P5” as they would appear on the display area 16a of the graphics display device 16. Where two windows overlap over this range of pixels, the image data from the two windows could be combined as follows: P1 is provided with the image data of one of the windows corresponding to the pixel P1; P2 is provided with the image data of the other window corresponding to the pixel P2; and so on. The control data may specify the range of pixel locations as well as one of a number of predetermined schemes for distributing the image data, or predetermined ranges of pixel locations and a single data distribution scheme may be employed. Priority may be taken into account, e.g., by weighting more heavily the usage of the image data corresponding to higher priority windows.

First and second tier functionality may be combined. With reference to FIG. 8, showing the same group of pixels shown in FIG. 7, the image data from the two windows could be combined as follows: P1 is provided with the image data of one of the windows corresponding to the pixel P1; P2 is provided with a combination that is the average of the image data for both windows corresponding to the pixel P2; P3 is provided with the image data of the other window corresponding to the pixel P3; and so on. Preferably, both first and second tier combining functionality is provided by the combining module 68.

The combining module 68 and the visual effects module 72 may be provided separately or together without departing from the principles of the invention. While the preferred window management module 68 is fully programmable, lesser degrees of programmability may alternatively be provided. The host 12 need only specify the parameters necessary to define the display of a plurality of windows. The host 12 need not carry out computations, logic, comparisons and selections provided by the module 68 and can therefore more quickly turn its attention away from the graphics controller 44 toward other tasks, providing an outstanding advantage in reducing host overhead and, therefore, reducing power consumption and increasing speed.

Referring again to FIG. 5, a partial panel update module 74a provides the capability to update the panel with sub-window display data independently from updating the panel with display data for the main window. The partial panel update capability is particularly advantageous where the display device 16 is provided with an on-board frame buffer memory. In one preferred embodiment, the host 12 provides control data specifying which regions 33, 34 of the memory 32 the image data are to be fetched from for transfer to the graphics display device 16. The partial panel update module 74a selects for transmission to the graphics display device 16 only image data corresponding to pixels falling within the specified regions. In general, referring to back to FIG. 2, assuming a raster scan order of transmission of the image data, specifying particular pixels (region “A”) requires specifying a line (a “y” value) and starting and stopping points (an “x-start” and an “x-stop” value) within the line. However, it is often the case that the control data specifying two “y” values (“y-start” and “y-stop”) and the two “x” values (“x-start” and “x-stop”) will provide sufficient specificity, depending on need.

The control data may additionally specify a refresh frequency for controlling the timing of data transfers to the graphics display device. Alternatively, the partial panel update module may be adapted to transfer data to the panel on receipt of a refresh trigger signal. The partial panel update function is intuitive and convenient for a software designer because it permits a panel update instruction to be included in the code that defines a window. When the code is executed, the image data defining the window are automatically provided to the panel. The ability to perform a partial panel update is particularly advantageous in the context of a separate graphics controller chip interfacing with the display device, because, even though all of the image data may be fetched in the graphics controller, a substantial power loss occurs in moving data off the graphics controller chip and into the graphics display device over an external bus.

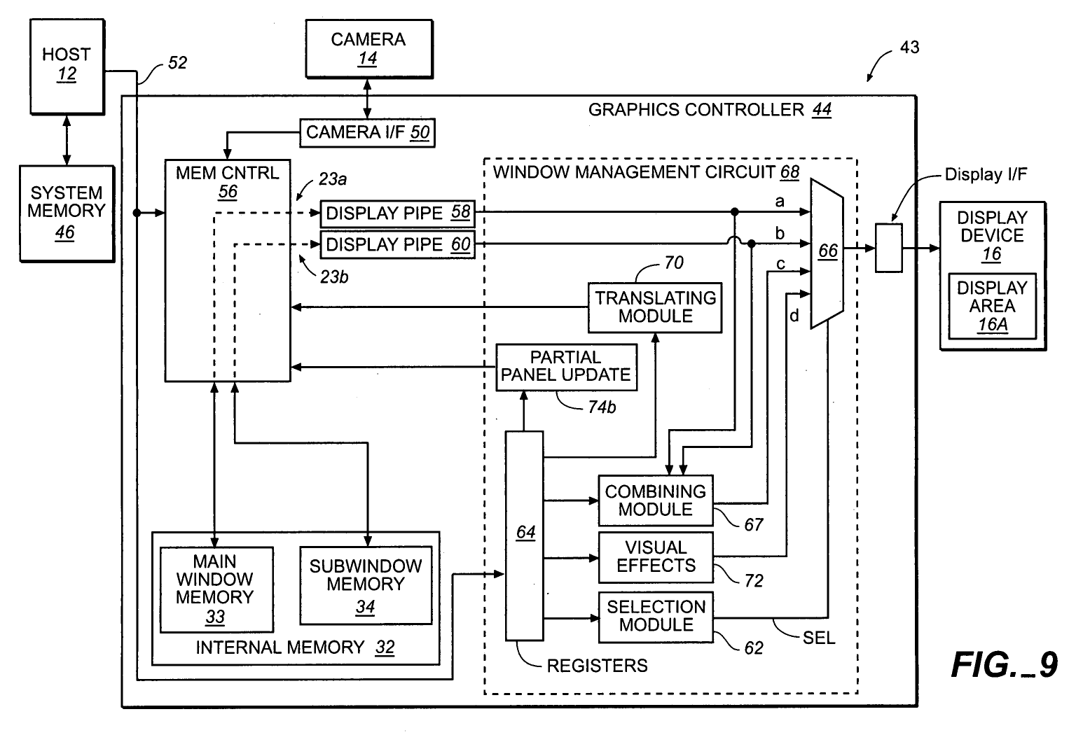

An alternative preferred embodiment of the window management circuit 68 is shown in FIG. 9. In this embodiment, a partial panel update module 74b interfaces with the memory controller 56 so as to provide the partial panel update function upstream of the display pipes 58, 60. As before, the host stores control data in a desired register for specifying particular pixels to be updated. The partial panel update module 74b employs the control data to direct the memory controller 56 to fetch from the memory 32 only the particular pixels to be updated. This provides a power savings over the partial panel update module 74a of FIG. 5A, which filters out undesired pixels after they have been fetched by the memory controller.

It is to be recognized that, while a particular graphics controller providing for enhanced window control has been shown and described as preferred, other configurations and methods could be utilized, in addition to those already mentioned, without departing from the principles of the invention. It should be noted, for example, that while a preferred system has been described where all data are fetched and operated on by the translation module, combining module, visual effects module, and the outputs of the various modules selected by the selection module, the modules may be adapted so that data and operations that are not to be selected are suppressed at earlier stages of processing. An example is the partial panel update module 74b as compared to the corresponding module 74a.

The functionality of the window management module 68 having been shown and described, it will be readily apparent to persons of ordinary skill how to implement the window management module, and further that the module may be implemented in numerous equivalent ways.

While the invention has been illustrated with respect to particular blocks and modules, it will be appreciated that the method of the invention may be also be embodied as a program of instructions that may be stored in a medium readable by a machine adapted to perform such instructions. For example, a graphics controller according an alternative embodiment of the invention may include a CPU block adapted to execute a program of instructions stored in a memory. In this example, the embedded CPU performs any of the operations or steps related providing for enhanced window control that have been described in this specification.

Accordingly, the window management module 68 may in alternative embodiments be implemented solely in hardware, software, or firmware. In additional alternative embodiments, the window management module 68 may be implemented in any combination of hardware, software, and firmware, provided the graphics controller is suitably adapted. In commercially sold embodiments of the invention, the module is economically implemented in mass production as a programmable logic array (“PLA”).

The terms and expressions which have been employed in the foregoing specification are used therein as terms of description and not of limitation, and there is no intention in the use of such terms and expressions to exclude equivalents of the features shown and described or portions thereof, it being recognized that the scope of the invention is defined and limited only by the claims which follow.

1. A graphics controller for interfacing between a host and a graphics display device, comprising:
a memory for storing at least a first portion of the image data corresponding to a first window of image data received by the graphics controller from the host;
a fetching module for first fetching said first portion to produce at least part of a first data stream that is in a parallel, clocked relation to a second data stream of the image data corresponding to a second window of image data received by the graphics controller from the host, said first and second data streams being provided to the graphics display device for display as multiple windows thereon; and
a window translating module coupled to said fetching module for temporally shifting said first fetching to provide a corresponding spatial translation of said first window with respect to said second window as displayed on the graphics display device.

2. The graphics controller of claim 1, wherein said memory is adapted for storing at least a second portion of the image data corresponding to said second window, wherein said fetching module is adapted for second fetching said second portion to produce at least part of said second data stream.

3. The graphics controller of claim 2, wherein said memory is adapted for storing said first and said second windows in substantially their entireties, and wherein said fetching module is adapted to produce said first and second data streams by fetching said first and second windows in substantially their entireties from said memory.

4. The graphics controller of claim 3, further comprising at least one register for receiving control data from the host defining an amount of said shift.

5. The graphics controller of claim 4, wherein said at least one register is adapted for receiving control data from the host defining a selected visual effect, further comprising a selecting module adapted to make a determination whether there are no image data corresponding to either of said first or second windows, and a visual effects module adapted to produce said visual effect according to said determination.

6. The graphics controller of claim 5, wherein said selecting module is adapted to make said determination for image data corresponding to a pixel on the display device, wherein said visual effects module is adapted to cause a selected color to be written to said pixel.

7. The graphics controller of claim 6, wherein said visual effects module is adapted to cause a plurality of selected colors to be written to a plurality of pixels on the. display device to define a repeating pattern.

8. The graphics controller of claim 5, wherein said at least one register is adapted for receiving control data from the host defining the priority of said first and second windows, wherein said selecting module is further adapted to make a determination whether said first and second windows overlap and selecting from said first data stream and said second data stream according to said determination.

9. The graphics controller of claim 5, wherein said at least one register is adapted for receiving control data from the host defining a combination of the image data corresponding to said first and second windows, wherein said selecting module is further adapted to make a determination whether said first and second windows overlap, and further comprising a combining module for forming said combination from image data of said first data stream and said second data stream.

10. The graphics controller of claim 4, wherein said at least one register is adapted for receiving control data from the host defining a combination of the image data corresponding to said first and second windows, further comprising a selecting module adapted to make a determination whether said first and second windows overlap, and a combining module for forming said combination from image data of said first data stream and said second data stream.

11. The graphics controller of claim 4, wherein said at least one register is adapted for receiving control data from the host defining a range of pixel locations, and further comprising a partial panel update module adapted to make a selection for transmission to the graphics display device of image data corresponding to said range.

12. The graphics controller of claim 11, wherein said partial panel update module is adapted to make said selection by controlling fetches from said memory.

13. The graphics controller of claim 11, further comprising a selecting module adapted to make a determination whether said first and second windows overlap and selecting from said first and second data streams according to said determination, wherein said partial panel update module is adapted to make said selection by controlling said selecting module.

14. The graphics controller of claim 13, wherein said at least one register is adapted for receiving control data from the host defining at least the relative priority of said first and second windows.

15. A graphics display system, comprising:
a host;
a graphics display device; and
a graphics controller for interfacing between said host and said graphics display device, said graphics controller comprising a memory for storing at least a first portion of the image data corresponding to a first window of image data received by said graphics controller from said host, a fetching module for first fetching said first portion to produce at least part of a first data stream that is in a parallel, clocked relation to a second data stream of the image data corresponding to a second window of image data received by said graphics controller from said host, said first and second data streams being provided to said graphics display device for display as multiple windows thereon, and a window translating module coupled to said fetching module for temporally shifting said first fetching to provide a corresponding spatial translation of said first window with respect to said second window as displayed on said graphics display device.

16. The system of claim 15, wherein said memory is adapted for storing at least a second portion of the image data corresponding to said second window, wherein said fetching module is adapted for second fetching said second portion to produce at least part of said second data stream.

17. The system of claim 16, wherein said memory is adapted for storing said first and said second windows in substantially their entireties, and wherein said fetching module is adapted to produce said first and second data streams by fetching said first and second windows in substantially their entireties from said memory.

18. The system of claim 17, wherein said graphics controller further comprises at least one register for receiving control data from said host defining an amount of said shift.

19. The system of claim 18, wherein said at least one register is adapted for receiving control data from said host defining a selected visual effect, said graphics controller further comprising a selecting module adapted to make a determination whether there are no image data corresponding to either of said first or second windows, and a visual effects module adapted to produce said visual effect according to said determination.

20. A method for interfacing between a host and a graphics display device, comprising:
storing at least a first portion of the image data corresponding to a first window of image data received by the graphics controller from the host;
first fetching said first portion to produce at least part of a first data stream that is in a parallel, clocked relation to a second data stream of the image data corresponding to a second window of image data received by the graphics controller from the host;
providing said first and second data streams to the graphics display device for display as multiple windows thereon; and
temporally shifting said first fetching to provide a corresponding spatial translation of said first window with respect to said second window as displayed on the graphics display device.

21. The method of claim 20, further comprising storing at least a second portion of the image data corresponding to said second window, and second fetching said second portion to produce at least part of said second data stream.

22. The method of claim 21, further comprising storing said first and said second windows in substantially their entireties in a memory in the graphics controller, and producing said first and second data streams by fetching said first and second windows in substantially their entireties from said memory.

23. The method of claim 22, further comprising receiving control data from the host defining an amount of said shift.

24. The method of claim 23, further comprising receiving control data from the host defining a selected visual effect, making a determination whether there are no image data corresponding to either of said first or second windows, and producing the selected visual effect according to said determination.

25. The method of claim 24, further comprising making said determination for image data corresponding to a pixel on the display device, and causing a selected color to be written to said pixel.

26. The method of claim 25, further comprising causing a plurality of selected colors to be written to a plurality of pixels on the display device to define a repeating pattern.

27. The method of claim 24, further comprising receiving control data from the host defining the priority of said first and second windows, making a determination whether said first and second windows overlap, and selecting from said first data stream and said second data stream according to said determination.

28. The method of claim 24, further comprising receiving control data from the host defining a combination of the image data corresponding to said first and second windows, making a determination whether said first and second windows overlap, and forming said combination from image data of said first data stream and said second data stream.

29. The method of claim 23, further comprising receiving control data from the host defining a combination of the image data corresponding to said first and second windows, making a determination whether said first and second windows overlap, and forming said combination from image data of said first data stream and said second data stream.

30. The method of claim 23, further comprising receiving control data from the host defining a range of pixel locations, and making a selection for transmission to the graphics display device of image data corresponding to said range.

31. The method of claim 30, further comprising making said selection by controlling fetches from said memory.

32. The method of claim 30, further comprising making a determination whether said first and second windows overlap, and selecting from said first and second data streams according to said determination.

33. The method of claim 32, further comprising receiving control data from the host defining at least the relative priority of said first and second windows.

34. A medium readable by a machine embodying a program of instructions executable by the machine to perform the method of claim 15.

35. A medium readable by a machine embodying a program of instructions executable by the machine to perform the method of claim 16.

36. A medium readable by a machine embodying a program of instructions executable by the machine to perform the method of claim 17.

37. A medium readable by a machine embodying a program of instructions executable by the machine to perform the method of claim 18.
